(19) United States
(12) Patent Application Publication
(10) Pub. No.: US 2009/0100922 A1
(43) Pub. Date: Apr. 23, 2009

(54) METHOD AND CONTROL APPARATUS FOR EVALUATING AN EXHAUST GAS PROBE

(76) Inventors: Krzysztof Korbel, Regensburg (DE); Gerd Rosel, Regensburg (DE); Norbert Sieber, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/171,704

(22) Filed: Jul. 11, 2008

(30) Foreign Application Priority Data
Jul. 20, 2007 (DE) 10 2007 034 057.7

(51) Int. Cl. G01M 15/00

(52) U.S. Cl. 73/114.72

(57) ABSTRACT

In a method and a control apparatus for monitoring an exhaust gas probe, the exhaust gas probe is arranged in an exhaust gas channel. The exhaust gas channel is connected to an internal combustion engine, with the internal combustion engine being supplied with a rich or lean air/fuel ratio in an oscillating fashion. An amplitude of a signal based on the oscillating output signal of the exhaust gas probe is determined and used to evaluate the exhaust gas probe.

### CROSS-REFERENCE TO RELATED APPLICATIONS

This application claims priority to German Patent Application Number 10 2007 026 408.0 filed on Jun. 6, 2007, and which is incorporated herein by reference in its entirety.

### TECHNICAL FIELD

The invention relates to a method for evaluating an exhaust gas probe and a control apparatus.

### BACKGROUND

Various methods are known, with which the functionality of an exhaust gas catalytic converter or a lambda probe are monitored.

By way of example, DE 103 32 057 B4 discloses the use of a method for monitoring an exhaust gas purification system which is connected to an exhaust gas tract of an internal combustion engine and which comprises a catalytic converter comprising an oxygen storage characteristic as well as a NOX sensor arranged downstream thereof in the exhaust gas tract. The NOX sensor emits a sensor signal which is dependent on the NOX and NH3 concentration in the exhaust gas, with the internal combustion engine being operated with an air/fuel ratio which oscillates periodically about the value lambda=1. A mean value of the sensor signal is formed over one or several periods of the air/fuel ratio oscillation and a catalytic converter is identified with a defective monolith when the mean value limit is exceeded.

DE 10 2005 059 794 B3 also discloses the use of a method for calibrating an exhaust gas probe. In this process, a plateau phase to be adjusted of a test signal of an exhaust gas probe arranged in an exhaust gas catalytic converter is consequently detected following a jump from a preset rich air/fuel ratio in a combustion chamber of a respective cylinder of an internal combustion engine to a preset lean air/fuel ratio and the duration of said plateau phase is determined as the storage period. A plateau phase consequently to be adjusted of the test signal is detected following a jump from a preset lean air/fuel ratio in the combustion chamber of the respective cylinder to a preset rich air/fuel ratio, and the duration of said plateau phase is determined as the storage period. An allocation rule for assigning the test signal to a detected air/fuel ratio is adjusted in accordance with the storage period and the evacuation period. In order to calibrate the exhaust gas probe, the allocation rule is adapted in accordance with a plateau value of the test signal.

### SUMMARY

According to an embodiment, a method for evaluating an exhaust gas probe, wherein the exhaust gas probe is arranged in an exhaust gas channel and the exhaust gas channel is connected to an internal combustion engine, may comprise the steps of: supplying the internal combustion engine with a rich or lean fuel ratio in an oscillating manner; and determining and using an amplitude of a signal based on the oscillating output signal of the exhaust gas probe to evaluate the exhaust gas probe.

According to another embodiment, a control apparatus has a data storage device comprising a data storage medium encoded with machine-executable instructions for performing a method for evaluating an exhaust gas probe, wherein the exhaust gas probe is arranged in an exhaust gas channel and the exhaust gas channel is connected to an internal combustion engine, the method comprising the steps of: supplying the internal combustion engine with a rich or lean fuel ratio in an oscillating manner, determining and using an amplitude of a signal based on the oscillating output signal of the exhaust gas probe to evaluate the exhaust gas probe.

According to an embodiment, the determined amplitude may be compared with a reference value, and a faulty exhaust gas probe may be identified when the measured amplitude is greater than a reference value. According to an embodiment, a frequency of the signal may be determined, the determined frequency may be compared with a determined frequency range, and the exhaust gas probe may be identified as defective if the determined frequency lies in the frequency range. According to an embodiment, the defect may be identified as a reaction delay of the exhaust gas probe. According to an embodiment, the comparison value may depend on a parameter of the internal combustion engine. According to an embodiment, the comparison value may depend on an operating point of the internal combustion engine. According to an embodiment, the parameter may illustrate a number of revolutions of the internal combustion engine. According to an embodiment, the parameter may illustrate a load of the internal combustion engine. According to an embodiment, a number of amplitudes of the signal may be determined, the number of amplitudes may be averaged, and the averaged amplitude may be used to evaluate the exhaust gas probe. According to an embodiment, an output signal of a lambda controller can be used as a signal, said output signal being used to determine an air/fuel ratio. According to an embodiment, a lambda probe may be used as an exhaust gas probe. According to an embodiment, the frequency of the signal may be averaged over several periods of the signal.

### BRIEF DESCRIPTION OF THE DRAWINGS

The invention is described in more detail below with reference to the Figures, in which:

FIG. 1 shows a schematic illustration of an internal combustion engine,

FIG. 2 shows a first diagram with control and test signals,

FIG. 3 shows a second diagram with control and test signals, and

FIG. 4 shows an enlarged illustration of an output signal of the lambda probe.

### DETAILED DESCRIPTION

One advantage of the above described method consists in it being possible to monitor an exhaust gas probe using simple means. According to various embodiments, an amplitude of a signal, which is based on an output signal of the exhaust gas probe, which is emitted during an oscillating operation between lean and rich air/fuel ratios, is used to evaluate the function of the exhaust gas probe. According to a further embodiment, the determined amplitude is compared with a reference value. If the comparison shows that the amplitude is greater than the reference value, a malfunction of the exhaust gas probe is identified. According to a further embodiment, a frequency of the signal is determined, with the determined frequency being compared with a determined frequency range, which depends on the oscillation of the rich and lean air/fuel ratios, with the lambda probe being identified as defective if the determined frequency lies in the frequency range. A clear assignment of the oscillation of the signal to the rich and lean phases of the air/fuel ratio is possible in this way. According to a further embodiment, a frequency range of a defective exhaust gas probe is used as a frequency range. A malfunction of an exhaust gas probe can also be identified with this comparison. According to a further embodiment, a response delay with the dead time and/or with the dynamic response characteristics of the exhaust gas probe, in particular the lambda probe, is identified as a defective exhaust gas probe. According to a further embodiment, the reference value is selected as a function of at least one parameter of an operating point of the internal combustion engine. A reliable and precise assignment of the reference values to the respective operating points of the internal combustion engine is possible in this way. According to a further embodiment, the number of revolutions or the load of the internal combustion is used as a parameter of the operating point. According to an additional embodiment, several amplitudes of the signal are determined and averaged and the averaged amplitude is compared with the reference value. The amplitudes can be detected over several periods. A further improvement to the method is possible in this way, since individual non-typical amplitudes are filtered out. In addition, the frequency of the signal can be averaged over several periods. An improvement is herewith also achieved.

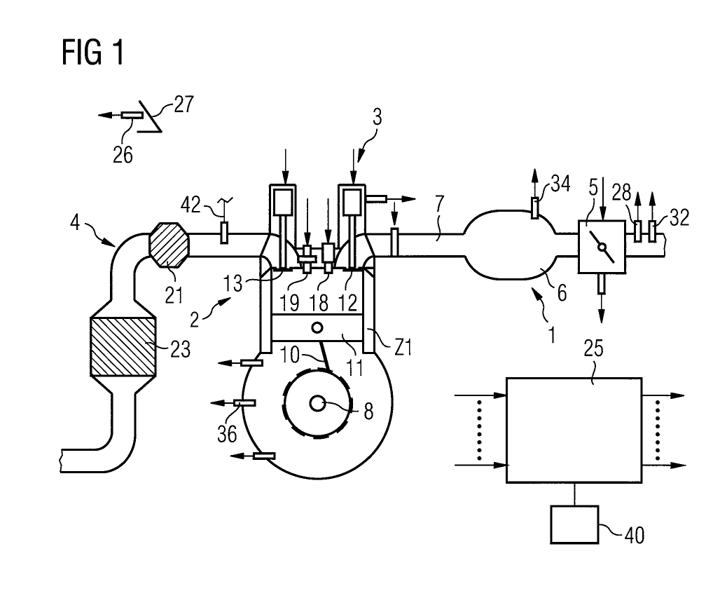

FIG. 1 shows a schematic illustration of an arrangement of an internal combustion engine with an intake tract 1, an engine block 2, a cylinder head 3 and an exhaust gas tract 4. The intake tract 1 preferably includes a throttle valve 5, and also a manifold 6 and an intake pipe 7, which is routed to a cylinder Z1 via an intake port in the engine block 2. The engine block 2 also includes a crankshaft 8, which is connected to a piston 11 of the cylinder Z1 by way of a connecting rod 10. The cylinder head 3 includes a valve drive with a gas inlet valve 12 and a gas outlet valve 13. The cylinder head 3 also has an injection valve 18 and a spark plug 19. Alternatively, the injection valve 18 can also be arranged in the intake pipe 7. Furthermore, there is no need for spark plugs 19 when diesel is used as the fuel.

An exhaust gas catalytic converter 21 is arranged in the exhaust gas tract 4, said exhaust gas catalytic converter being embodied as a three-way catalytic converter for instance. A further exhaust gas catalytic converter 23 can also be arranged in the exhaust gas tract, which is embodied as a NOX catalytic converter for instance. A control apparatus 25 is also provided, to which sensors are assigned, which record the different measured quantities and forward them to the control apparatus 25. The control apparatus 25 determines actuating variables as a function of at least one of the measured quantities, said actuating variables then being converted into one or a number of actuating signals in order to control actuating elements by means of corresponding actuating drives.

A pedal position indicator 26, which detects a position of a gas pedal 27, an air mass flow meter 28, which detects an air mass flow upstream of the throttle valve 5, a first temperature sensor 32, which detects an intake air temperature, an inlet manifold pressure sensor 34, which detects an inlet manifold pressure in the manifold 6, and a crankshaft angle sensor 36, which detects a crankshaft angle, from which a rotational speed can be calculated are provided as sensors for instance.

In addition, an exhaust gas probe 42 is provided, which is arranged in the exhaust gas tract 4 upstream of the exhaust gas catalytic converter 21. The exhaust gas probe 42 detects a residual oxygen content of the exhaust gas and emits an output signal to the control apparatus 25, which is characteristic of an air/fuel ratio in the combustion chambers of the internal combustion engine. The exhaust gas probe 42 can be a linear lambda probe or a binary lambda probe for instance. Additional sensors or fewer sensors than cited can be provided as a function of the selected embodiment. The throttle valve 5, the gas inlet and gas outlet valves 12, 13, the injection valve 18 or the spark plugs 19 are provided as actuating elements for instance, which are controlled by the control apparatus 25, in order to implement a desired combustion in the combustion chamber of the internal combustion engine.

The control apparatus 25 is connected to a data storage device 40, in which control processes for operating the internal combustion engine and reference values for the evaluation of the exhaust gas probe 42 are stored.

The control apparatus 25 operates the internal combustion engine as a function of the pedal position of the gas pedal 27 in accordance with the stored control program. In this process, the internal combustion engine is operated at different operating points as a function of the gas pedal position for instance. A parameter of an operating point can consist in the air/fuel ratio, with which the internal combustion engine is operated, oscillating about a determined lambda value. To this end, the control apparatus 25 correspondingly controls the fuel and air supply such that the air/fuel ratio oscillates about the determined value, lambda=1 for instance. This can take place with a normal engine operation or can be implemented during a forced excitation in order to evaluate the exhaust gas probe 42.

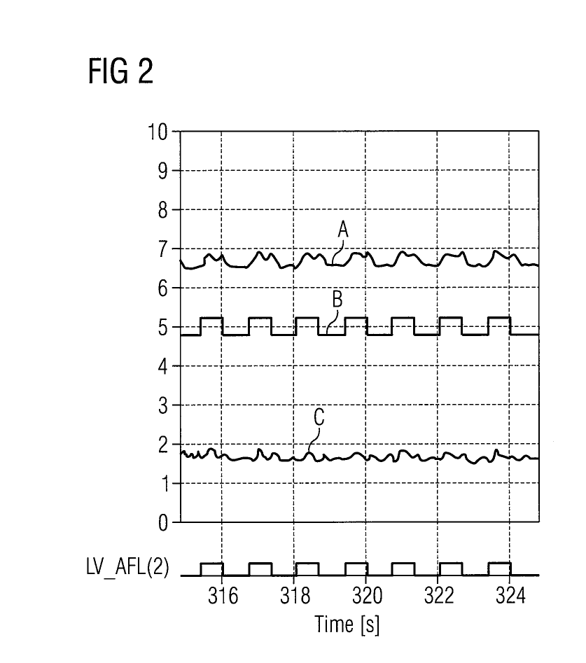

The diagram in FIG. 2 shows an output signal of a linear lambda probe, which is used as an exhaust gas probe 42 in the arrangement in FIG. 1, in an upper characteristic curve A. In a second characteristic curve B, an excitation signal is specified, which is fed to the control apparatus 25 in order to control the lean/rich phases, with a lower value of the excitation signal determining a lean phase and an upper value of the excitation phase determining a rich phase. In a third characteristic curve C illustrated therebelow, a lambda controller intervention is used to control the rich/lean phases. LV_AFL (2) designates the rich/lean phases. A lambda controller is stored in the data storage device 40 as a control method for instance. The lambda controller compares a target value for the lambda value with a recorded actual value, which is determined by the output signal of the exhaust gas probe. The target values for the lambda value depend on the operating parameters of the internal combustion engine and are stored in the data storage device 40. From the comparison, the lambda controller calculates a control variable, the lambda controller intervention, which is used by the control apparatus 25 to achieve the target value. The lambda controller intervention oscillates according to the forced excitation and is fed to the control apparatus 25.

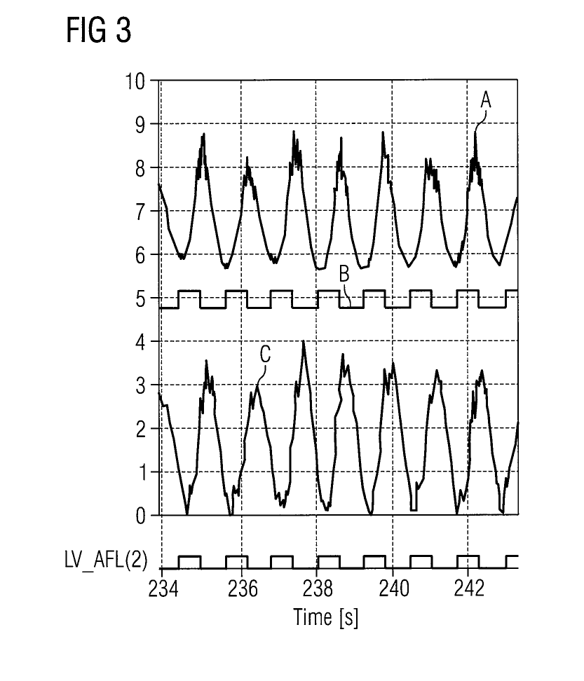

FIG. 3 shows a second diagram, a linear lambda probe, which has a reaction delay as a result of ageing, with the reaction delay lying at 250 ms. In an upper characteristic curve A, the output signal of the lambda probe is shown. The excitation signal is shown in the middle characteristic curve B, with which the control apparatus 25 carries out an oscillation of the rich/lean phases. In a lower characteristic curve C, the output of the lambda controller is shown, i.e. the lambda controller intervention which is fed to that of the control apparatus 25.

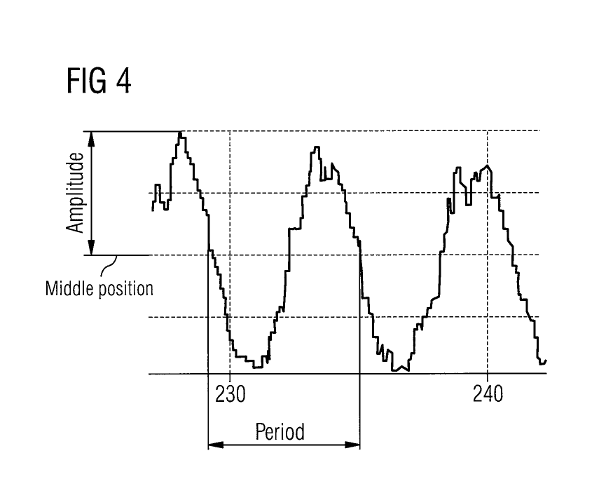

FIG. 4 shows an enlarged illustration of the signal of the lambda controller output, which oscillates about a center position with an amplitude and a period. The amplitude and/or the period of the output signal of the lambda controller output is determined.

The determined amplitude is used to evaluate the lambda probe. Tests have shown that the amplitudes of the controller output adopt excessive values with an aged lambda probe. By way of example, it has been shown that exceeding a normal value can indicate a defective lambda probe. A defective lambda probe can be reliably detected when a normal value for the amplitude, which is stored in the data storage device as a reference value, increases by more than 50%. In a selected embodiment, reference values for the amplitudes are stored in the data storage device as a function of an operating point of the internal combustion engine, in particular as a function of the number of revolutions and/or load.

A further improvement to the method is herewith achieved in that the period of the signal of the lambda controller output, i.e. the frequency, is detected and is compared with a determined frequency range. The determined frequency range corresponds to the determined bandwidth of an oscillation frequency, with which the air/fuel ratio is determined by the control apparatus. This can be determined particularly precisely if the control apparatus allows the air/fuel ratio to oscillate about a predetermined lambda value, in particular lambda 1, on the basis of a determined forced excitation with a determined frequency. The determined frequency range can correspond to the frequency of the forced excitation for instance, with a frequency width of plus or minus 10% to be considered.

If the monitoring process detects that the amplitude of the output signal of the lambda controller deviates by more than one determined value from the reference value, a defective lambda probe is identified. Comparing the frequency of the output signal of the lambda controller with the determined frequency and/or with the determined frequency range clearly allows an assignment of the output signal of the lambda controller to the oscillation of the rich/lean phases by means of the control apparatus. This thus ensures that the amplitude of the output signal of the lambda controller was generated on the basis of the oscillation of the air/fuel ratio by means of the control apparatus.

In a further embodiment, a frequency or a frequency range of a defective exhaust gas probe is used as a defined frequency or defined frequency range. Comparing the frequency of the signal of the exhaust gas sensor with the defined frequency or the defined frequency range allows a malfunction of the exhaust gas probe to be identified if the frequency of the exhaust gas probe lies in the defined frequency range or corresponds to the defined frequency.

In a further embodiment, a number of amplitudes of the output signal of the lambda controller are detected and an average value is formed. The average value is compared with a reference value. The reference value can be determined for instance from reference values of the corresponding operating points of the internal combustion engine, which correspond to the amplitudes.

Instead of the lambda controller signal, other signals, such as for instance the signal of the exhaust gas probe 42 or an oscillating signal dependent on the signal of the exhaust gas probe 42, can be used.

What is claimed is:

1. A method for evaluating an exhaust gas probe, wherein the exhaust gas probe is arranged in an exhaust gas channel and the exhaust gas channel is connected to an internal combustion engine, the method comprising the steps of:
supplying the internal combustion engine with a rich or lean fuel ratio in an oscillating manner,
determining and using an amplitude of a signal based on the oscillating output signal of the exhaust gas probe to evaluate the exhaust gas probe.

2. The method according to claim 1, wherein the determined amplitude is compared with a reference value, and a faulty exhaust gas probe is identified when the measured amplitude is greater than a reference value.

3. The method according to claim 1, wherein a frequency of the signal is determined, the determined frequency is compared with a determined frequency range, and the exhaust gas probe is identified as defective if the determined frequency lies in the frequency range.

4. The method according to claim 2, wherein the defect is identified as a reaction delay of the exhaust gas probe.

5. The method according to claim 1, wherein the comparison value depends on a parameter of the internal combustion engine.

6. The method according to claim 1, wherein the comparison value depends on an operating point of the internal combustion engine.

7. The method according to claim 5, wherein the parameter illustrates a number of revolutions of the internal combustion engine.

8. The method according to claim 6, wherein the parameter illustrates a number of revolutions of the internal combustion engine.

9. The method according to claim 4, wherein the parameter illustrates a load of the internal combustion engine.

10. The method according to claim 1, wherein a number of amplitudes of the signal is determined, the number of amplitudes is averaged, and the averaged amplitude is used to evaluate the exhaust gas probe.

11. The method according to claim 1, wherein an output signal of a lambda controller is used as a signal, said output signal being used to determine an air/fuel ratio.

12. The method according to claim 1, wherein a lambda probe is used as an exhaust gas probe.

13. The method according to claim 3, wherein the frequency of the signal is averaged over several periods of the signal.

14. A control apparatus with a data storage device comprising a data storage medium encoded with machine-executable instructions for performing a method for evaluating an exhaust gas probe, wherein the exhaust gas probe is arranged in an exhaust gas channel and the exhaust gas channel is connected to an internal combustion engine, the method comprising the steps of:
supplying the internal combustion engine with a rich or lean fuel ratio in an oscillating manner,
determining and using an amplitude of a signal based on the oscillating output signal of the exhaust gas probe to evaluate the exhaust gas probe.

15. The control apparatus according to claim 14, wherein the determined amplitude is compared with a reference value, and a faulty exhaust gas probe is identified when the measured amplitude is greater than a reference value.

16. The control apparatus according to claim 14, wherein a frequency of the signal is determined, the determined frequency is compared with a determined frequency range, and the exhaust gas probe is identified as defective if the determined frequency lies in the frequency range.

17. The control apparatus according to claim 15, wherein the defect is identified as a reaction delay of the exhaust gas probe.

18. The control apparatus according to claim 14, wherein the comparison value depends on a parameter of the internal combustion engine.

19. The control apparatus according to claim 18, wherein the parameter illustrates a number of revolutions of the internal combustion engine.

20. The control apparatus according to claim 17, wherein the parameter illustrates a load of the internal combustion engine.
